(19) United States
(12) Patent Application Publication
(10) Pub. No.: US 2016/0302482 A1
(43) Pub. Date: Oct. 20, 2016

(54) PORTABLE EXTENDABLE RECEPTACLE

(71) Applicant: James O'Loughlin, Irvington, NJ (US)

(72) Inventor: James O'Loughlin, Irvington, NJ (US)

(21) Appl. No.: 15/133,936

(22) Filed: Apr. 20, 2016

Related U.S. Application Data
(60) Provisional application No. 62/150,081, filed on Apr. 20, 2015.

(51) Int. Cl. A24F 19/00; B65D 25/28; B25J 1/04

(52) U.S. Cl. CPC A24F 19/0092; B25J 1/04; B65D 25/28; B65D 2525/285; B65D 2525/287; B65D 2525/289

(57) ABSTRACT

A receptacle with a detachable, collapsible handle is provided for. It is constructed out of a receptacle, having a bottom surface and at least one edge; a handle; and an attachment mechanism, wherein said mechanism provides for the removable attachment of the handle to the receptacle. The handle can be extendable, and is optionally equipped with a motor to automatically the extension contraction of this handle. In some embodiments, the handle of the receptacle contains a release mechanism. This can be, for example, a button that disengages an electromagnet, or a lever that disengages a spring clip.

### CLAIM OF PRIORITY

This application claims priority to U.S. Provisional Patent Application No. 62/150,081, entitled “PORTABLE EXTENDABLE RECEPTACLE”, filed on Apr. 20, 2015.

### FIELD OF THE EMBODIMENTS

This invention relates to a portable receptacle. In particular, the present invention relates to an apparatus that allows a plurality of users to share a receptacle when the users are located more than an arm's reach away from each other. The present invention is suitable for use as an ashtray.

### BACKGROUND OF THE EMBODIMENTS

Since at least 1603, smoking has been part of society where King James of England's commentary on smoke has been documented. Since that time, smoking has grown in popularity. As smoking has grown in popularity, the market for smoking paraphernalia and accessories has grown in kind. Chief among these accessories has been the ashtray. Made popular in America in the early 1900's, ashtrays have had a storied history.

Until the early 20^{th} century, ashtrays were not a part of everyday life. However, around that time cigarette manufactures began marketing ashtrays to the American public. With this push, ashtrays became ubiquitous with smoking in America. From the early 1940s to the 1990s many different iterations of ashtrays were developed. Some of these ashtrays were highly ornate, some included functional features such as grooves to rest a lit cigarette in. However, since the early 1990s, the act of smoking has become more and more taboo and a number of laws have been passed preventing people from smoking in a number of outdoor areas.

As a direct result of this paradigm shift, smoking is becoming an increasingly indoors activity. This migration to confined spaces comes with onerous restrictions on the logistics of sharing an ashtray with a plurality of people. While outdoor spaces provided ample space for people to congregate around an ashtray so that all smokers may simultaneously use the ashtray, frequently the dimensions of various indoor spaces preclude such a use of an ashtray indoors. Thus, there is a need for a device that allows a number of smokers to use an ashtray when it is impossible for all of the smokers to be within an arm's reach of the ashtray.

Examples of related art are described below:

U.S. Pat. No. 4,697,780 to Wenkman, et al. discloses a beverage container holder kit. This kit can be mounted adjacent to the edge of a horizontal surface, on a vertical surface, on a horizontal surface, or hanging from a narrow object, such as a wall or panel. This kit includes a receptacle element, a support bracket and a mounting element. The mounting element may be physically adhered to the mounting surface and the receptacle element may be either mounted on the mounting element the support bracket. Instead of using the mounting element, the support bracket may be bent to hook over a narrow object.

U.S. Pat. No. D256,279 to Huggins discloses a combination ashtray and beverage can holder.

U.S. Pat. No. 3,108,316 to Peale discloses a single handle which removably locks onto a handleless utensil. These utensils may be selected from a number of related utensils or containers, provided that all of the utensils are otherwise handleless. A combination of a single handle with a multiplicity of otherwise handless containers or utensils is also disclosed.

None of the art described above addresses all of the issues that the present invention does.

The need for an apparatus that provides for a way for multiple smokers to simultaneously use the same ashtray when they are limited geospatially.

### SUMMARY OF THE EMBODIMENTS

The present invention provides for, an apparatus, comprising: a receptacle, having a bottom surface and at least one edge; a handle; an extension member attached to said handle; and an attachment mechanism, wherein said attachment mechanism is connected to said receptacle and to said extension member, and wherein said mechanism provides for the removable attachment of the extension member to the receptacle. In some embodiments this handle is extendable, and in other embodiments, the present invention is equipped with a power source; and an extension assistance mechanism, wherein said extension assistance mechanism is capable of extending and/or retracting said extension member.

The present invention contemplates many different attachment mechanisms, including, but not limited to, ball and socket joints, hook and loop fasteners, spring clamp, magnets, bolt and wing nut, complimentary shaped receptacle, pin lock, snap buckle, and ‘C’ clamp. In some embodiments, the present invention comprises a release mechanism. This can be, for example, a button that disengages an electromagnet, or a lever that disengages a spring clip.

In a preferred embodiment, the weight of the present invention is distributed such that it rests evenly when set down on a flat surface. This has the benefit of assisting the prevention of the contents of the receptacle being spilled. In another preferred embodiment, the receptacle is equipped with a lid. In some embodiments, this lid is merely decorative, and in other embodiments said lid is functional. In another preferred embodiment, the receptacle is equipped with at least one receiving slot, suited to accommodate user's cigarettes, cigars, and other similar products. In another embodiment, the receptacle is equipped with an auxiliary storage area, suitable for holding a number of smoking accoutrements. This auxiliary storage area can be made of mesh, or any other suitable material.

In alternative embodiments, the present invention may be equipped with any or all of the following: a plurality of light sources, a rubber grip, and/or a storage hook. In a preferred embodiment, storage hook is attached to either receptacle or extension member. Further, in yet another embodiment, the receptacle is comprised of two chambers, an upper chamber to receive contents, and a lower chamber to receive particulate matter that falls through a hole in the upper chamber.

The present invention provides benefits to members of a number of different industries.

It is an object of the present invention to provide a means for receiving ash generated by smoking.

It is an object of the present invention to provide a convenient means for multiple users to simultaneously share an ashtray while smoking.

It is an object of the present invention to provide a way to smoke indoors without creating undue mess.

### BRIEF DESCRIPTION OF THE DRAWINGS

FIG. 1 shows a front perspective view of an embodiment of the present invention.

FIGS. 2A-2C show side views of an embodiment of the present invention, highlighting its removably attachable nature.

FIGS. 3A-3E show side views of various embodiments of the attachment mechanism of the present invention.

FIGS. 4A and 4B show front perspective views of an embodiment of the present invention in use, in both a collapsed and extended position.

FIGS. 5A and 5B show a side view of an embodiment of the present invention, highlighting the mechanism of one embodiment of the extension assistance mechanism.

FIG. 6 shows a perspective view of an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

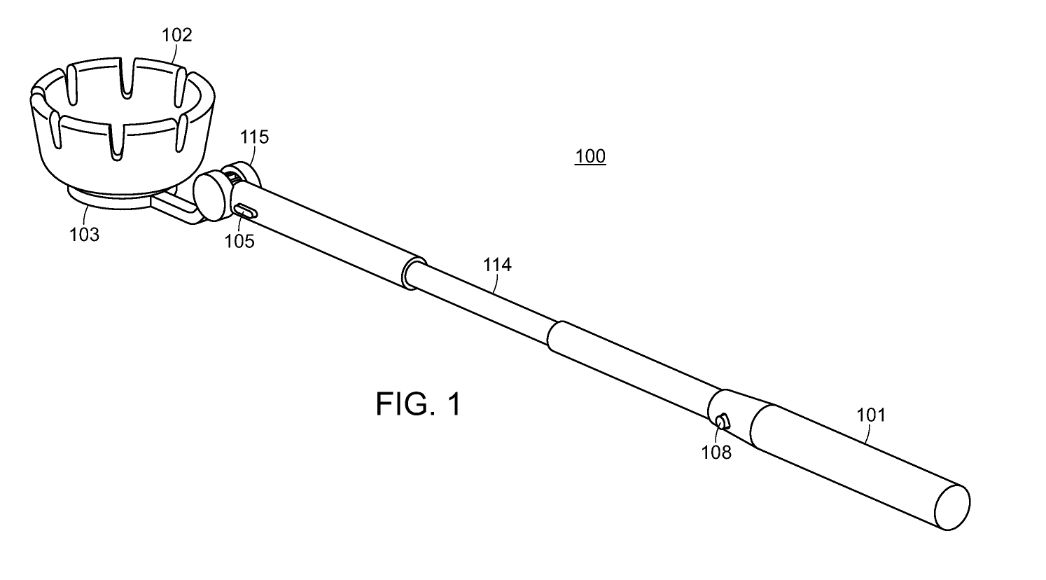

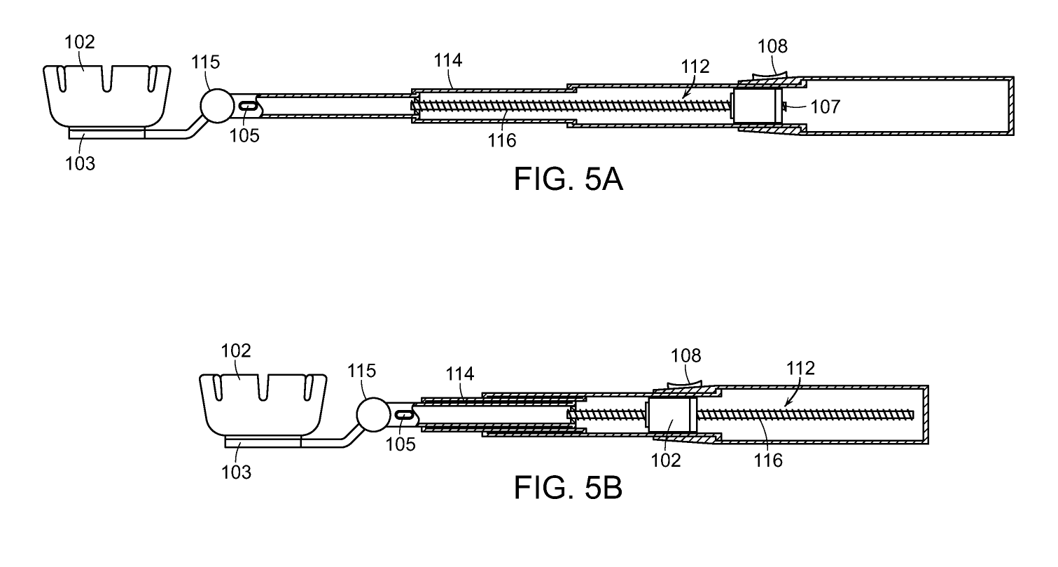

Referring to FIG. 1, an embodiment of apparatus 100 is shown. Here, apparatus 100 is shown in an extended position. Handle 101 is connected to extension member 114. While shown in an extended position here, extension member 114 can be collapsed to provide for easier access to receptacle 102, as well as increasing the number of places in which apparatus 100 may be stored when not in use. Handle button 108 is located on handle 101. In a preferred embodiment, handle button 108 controls extension assistance mechanism 112 (See FIG. 5A). In one embodiment, extension assistance mechanism 112 is comprised of a hydraulic piston which is allowed to extend upon the engagement of handle button 108. In this embodiment, handle button 108 may be comprised of a rocker, wherein said rocker is capable of engaging the motor in both a forward and a reverse direction. This functionality provides for a user to enjoy fully automated extension and retraction of apparatus 100. Further, FIG. 1 shows receptacle 102 attached to collapsing mechanism 115, via attachment mechanism 103, which is attached to extension member 114. This view also shows second release button 105. Here, second release button 105 engages collapsing mechanism 115. In a preferred embodiment, collapsing mechanism 115 is comprised of a spring hinge and a mechanism that allows for collapsing mechanism 115 to be locked in either an extended or collapsed position. Collapsing mechanism 115 is intended to increase the overall portability and ease of storage of apparatus 100.

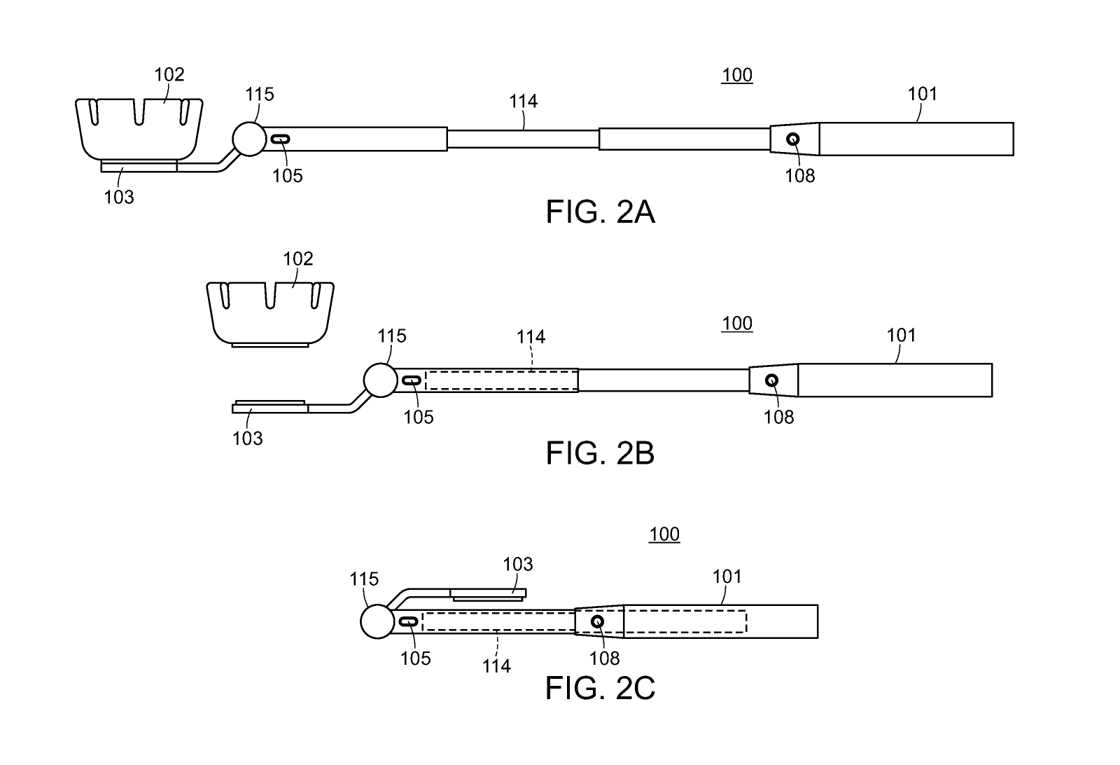

Referring to FIGS. 2A-2C, a side view of an embodiment of the present invention in various states of collapse. Specifically, FIG. 2A shows apparatus 100 in a fully extended position, further illustrating the location of handle button 108 and second release button 105. FIG. 2B highlights the detachable nature of receptacle 102 from attachment mechanism 103. In this embodiment, attachment mechanism 103 is comprised of complementarily charged magnets, but many other attachment mechanisms are contemplated by the current application. FIG. 2B also shows extension member 114 being partially collapsed. This is intended to show how this particular embodiment of extension member 114 collapses. In particular, this embodiment of extension member 114 is comprised of a telescoping tube, which sections collapse upon each other. FIG. 2C shows this particular embodiment of apparatus 100 being fully collapsed. Of note is how a portion of extension member 114 extends into handle 101 and how collapsing mechanism 115 collapses to be substantially parallel with extension member 114 and handle 101. In a preferred embodiment, the collapsing illustrated by FIGS. 2A-2C is engaged by handle button 108 and second release button 105.

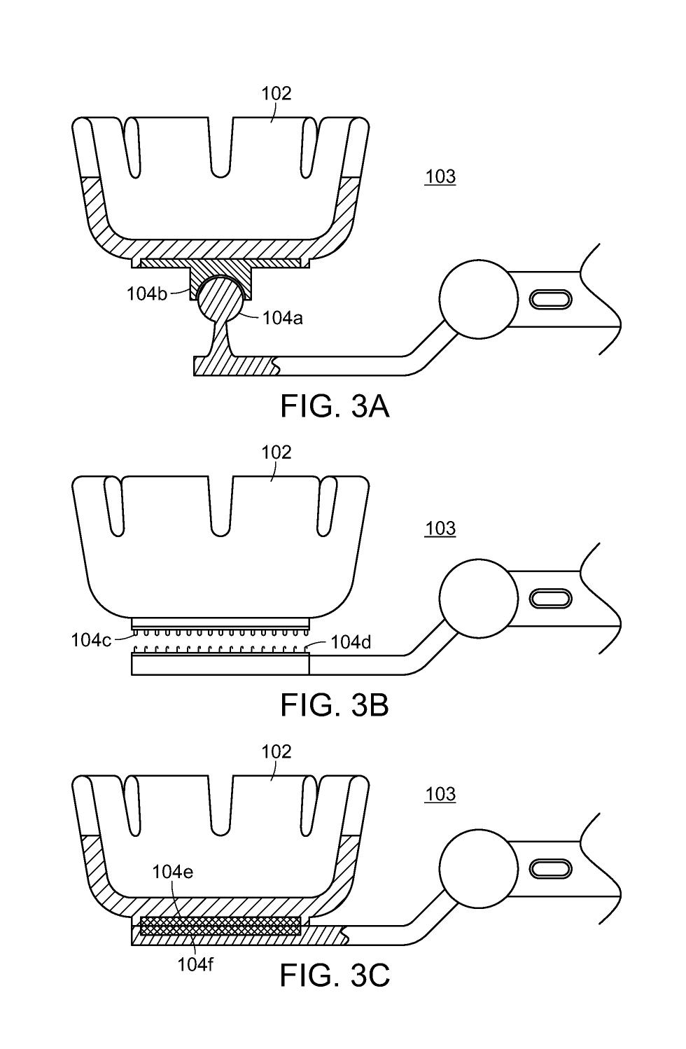

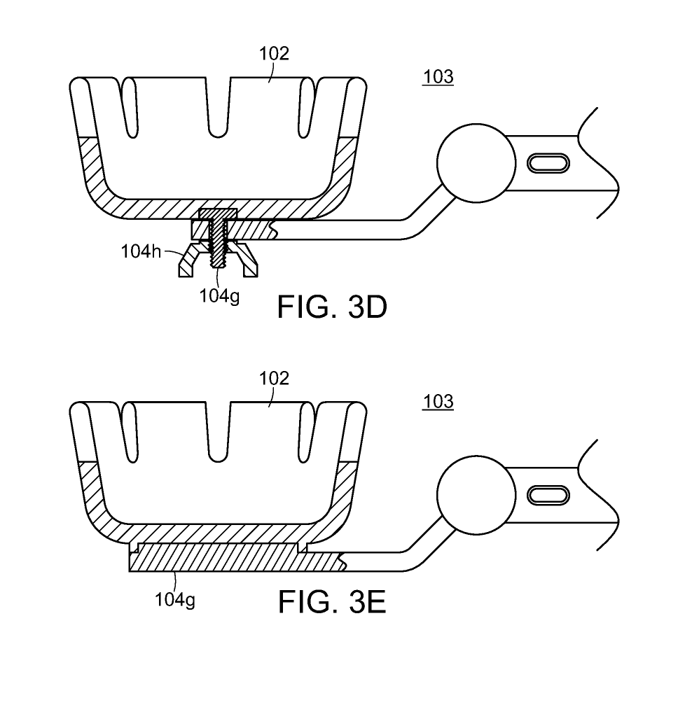

Referring to FIGS. 3A-3E, a number of embodiments of attachment mechanism 103 are shown. FIG. 3A shows attachment mechanism 103 as a ball and socket joint. Here, ball 104a is attached to collapsing mechanism 115. In a preferred embodiment, ball 104a is permanently affixed to collapsing mechanism 115. Further, socket 104b is attached to receptacle 102. In another preferred embodiment, socket 104b is permanently affixed to receptacle 102. Ball 104a and socket 104b provide for a limited friction fit between collapsing mechanism 115 and receptacle 102. Specifically, this will allow for receptacle 102 to rest at a plurality of different angles, providing for greater ease of access to receptacle 102. Ball 104a and socket 104b can be constructed out of, but not limited to, steel, plastic, wood, or iron.

FIG. 3B shows an embodiment of attachment mechanism 103, wherein attachment mechanism 103 is comprised of hook fasteners 104c and loop fasteners 104d. Hook fasteners 104c and loop fasteners 104d may be alternatively attached to receptacle 102 and collapsing mechanism 115.

FIG. 3C shows an embodiment of attachment mechanism 103, wherein attachment mechanism 103 is comprised out of magnets 104e and 104f. In a preferred embodiment, these magnets are inherently magnetic. In another preferred embodiment, magnets 104e and 104f are electromagnets, whose electromagnetism may be disengaged by depressing second release button 105. This embodiment of attachment mechanism 103 is intended to provide for easy removable attachment of receptacle 102 to collapsing mechanism 115.

FIG. 3D shows an embodiment of attachment mechanism 103, wherein attachment mechanism 103 is comprised of bolt 104g and wing nut 104h. In this embodiment, bolt 104g is permanently attached to receptacle 102, and collapsing mechanism 115 is equipped with a hole to receive bolt 104g. Upon insertion of bolt 104g into the hole of collapsing mechanism 115, wing nut 104h is used to secure receptacle 102 to collapsing mechanism 115.

FIG. 3E shows an embodiment of attachment mechanism 103, wherein attachment mechanism 103 is integrated with collapsing mechanism 115 in the form of a complimentary shaped holder, wherein said holder is shaped to receive the bottom of receptacle 102. While this embodiment of attachment mechanism 103 does not lock receptacle 102 into collapsing mechanism 115, this construction is a low-cost alternative to the other embodiments.

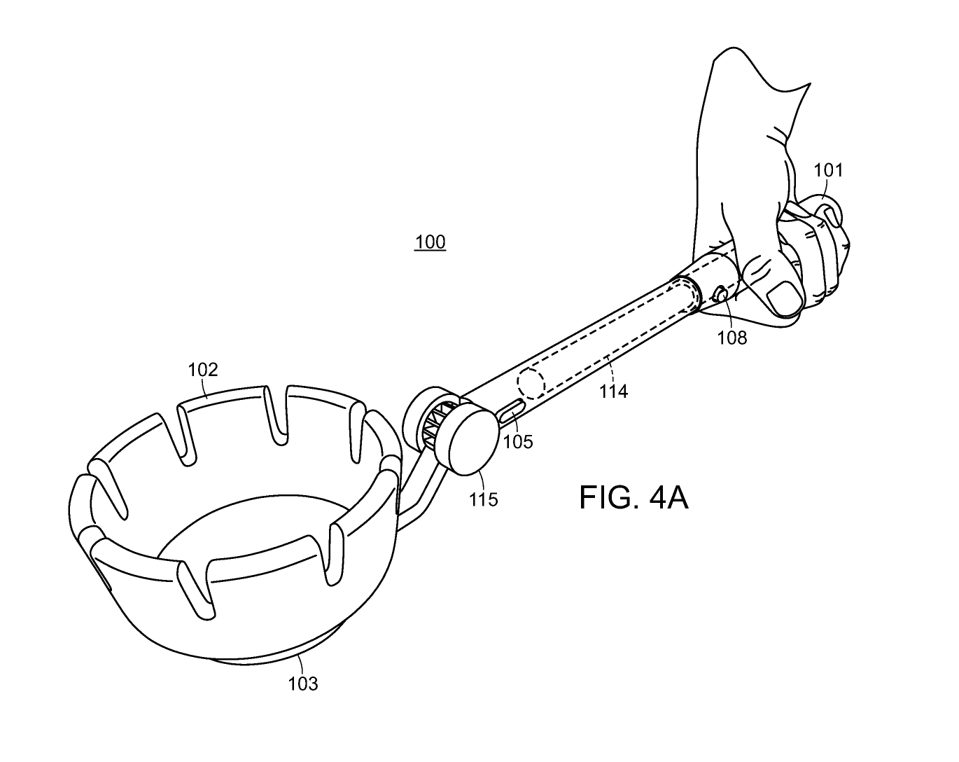

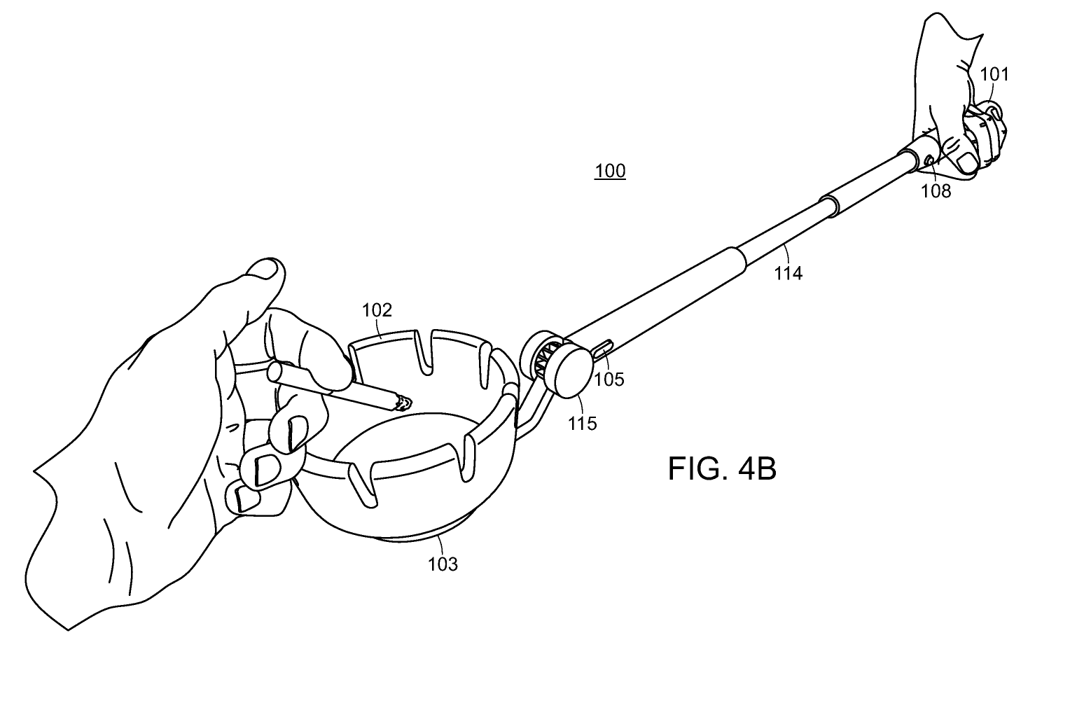

Referring to FIGS. 4A and 4B, and embodiment of the present invention is shown while in use. FIG. 4A shows apparatus 100 with extension member 114 in a collapsed position, but collapsing mechanism 115 in an extended position with receptacle 102 still attached. FIG. 4A also shows handle button 108, second release button 105, and attachment mechanism 103.

FIG. 4B shows a first user holding handle 101 of apparatus 100, while a second user is utilizing receptacle 102 from a distance away from the first user. Here, extension member 114 and collapsing mechanism 115 are both an in extended position. This view also shows the relative position of receptacle 102, attachment mechanism 103, second release button 105, and handle button 108.

Referring to FIG. 5A, a side view of an embodiment of the present invention is provided. Here, extension assistance mechanism 112 is highlighted. In this particular embodiment, extension assistance mechanism 112 comprises a linear actuator, which in turn is comprised of screw 116 and motor 107. Screw 116 is threaded through motor 107 and on one of its ends is fixed to a portion of extension member 114. In a preferred embodiment, extension member 114 comprises a telescoping tube. In this preferred embodiment, handle button 108 is in the form of a rocker. This rocker will allow a user to engage motor 107 in both a forward and reverse direction. Accordingly, a user may then use handle button 108 to fully extend or fully collapse extension member 114. This view also shows receptacle 102, attachment mechanism 103, collapsing mechanism 115, and second release button 105. FIG. 5B shows the same embodiment of the present invention as FIG. 5A, however, in this view extension member 114 is fully collapsed. Note that in various embodiments the proportion of extension mechanism 114 and handle 101 are subject to change.

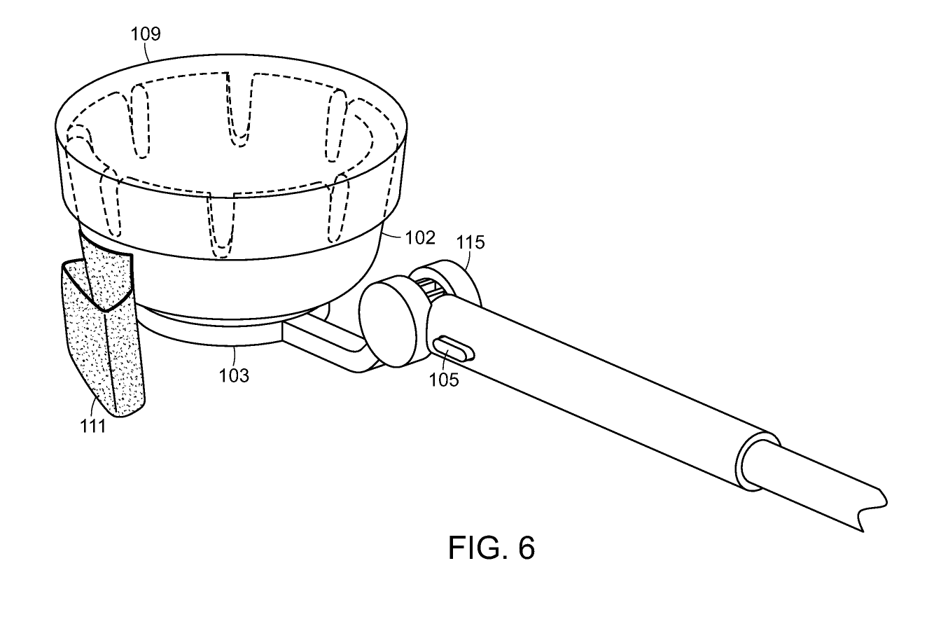

FIG. 6 shows a perspective view of an alternative embodiment of the present invention. Here, lid 109 is placed over receptacle 102. Lid 109 may be purely cosmetic, or in a preferred embodiment, it forms an odor-proof seal with receptacle 102. Alternatively, lid 109 may be shaped such that the contents of receptacle 102 may be placed in lid 109 and subsequently disposed of. FIG. 6 also shows auxiliary storage area 111. Preferably, this area is constructed out of fabric, even more preferably a mesh lattice, however a number of suitable materials exist. FIG. 6 further illustrates the relationship between attachment mechanism 103, receptacle 102, collapsing mechanism 115 and second release button 105.

In a preferred embodiment, the present invention further comprises an auxiliary storage area, attached to receptacle 102. In another preferred embodiment, this auxiliary storage area is constructed out of mesh. In yet another preferred embodiment, the present invention further comprises a lid to be placed on top of receptacle 102.

In another embodiment, receptacle 102 is comprised of two parts, an upper chamber to receive contents immediately disposed of and a lower chamber, capable of receiving any overflow contents from the upper chamber. Preferably, this lower chamber will be easily removed from the upper chamber to provide for easy cleaning.

In preferred embodiment, the present invention is constructed without collapsing mechanism 115. In that instance, extension member is attached directly to receptacle 102.

In another preferred embodiment, the present invention is shaped such that it will rest evenly on a flat surface. For example, this could be achieved by distributing the weight of this embodiment appropriately, by utilizing a rectangular prism-like shape for the handle, or by equipping the present invention with at least one pair of legs.

In yet another preferred embodiment, the present invention is equipped with a rubber grip. In a preferred embodiment, the present invention is equipped with a storage hook, or an alternative storage means. In another embodiment, the present invention is equipped with a plurality of light sources. These lights may be for example, LED, incandescent, or fluorescent lights.

Although this invention has been described with a certain degree of particularity, it is to be understood that the present disclosure has been made only by way of illustration and that numerous changes in the details of construction and arrangement of parts may be resorted to without departing from the spirit and the scope of the invention.

Various other components may be included and called upon for providing for aspects of the teachings herein. For example, additional materials, combinations of materials and/or omission of materials may be used to provide for added embodiments that are within the scope of the teachings herein. In the present application a variety of variables are described, including but not limited to components and conditions. It is to be understood that any combination of any of these variables can define an embodiment of the disclosure. Other combinations of articles, components, conditions, and/or methods can also be specifically selected from among variables listed herein to define other embodiments, as would be apparent to those of ordinary skill in the art.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. An apparatus, comprising:
a receptacle, having a bottom surface and at least one edge;
a handle;
an extension member attached to said handle; and
an attachment mechanism,
wherein said attachment mechanism is connected to said receptacle and to said extension member, and
wherein said mechanism provides for removable attachment of the extension member to the receptacle.

2. The apparatus of claim 1, wherein said handle is extendable.

3. The apparatus of claim 2, further comprising:
a power source; and
an extension assistance mechanism,
wherein said extension assistance mechanism is capable of extending and/or retracting said extension member.

4. The apparatus of claim 1, wherein said attachment mechanism is selected from the group consisting of a ball and socket joints, hook and loop fasteners, spring clamp, magnets, bolt and wing nut, complimentary shaped receptacle, pin lock, snap buckle, and ‘C’ clamp.

5. The apparatus of claim 3, further comprising a handle button,
wherein said handle button is configured to operate said extension assistance mechanism.

6. The apparatus of claim 1, further comprising:
a pair of legs attached to said receptacle; and
a pair of legs attached to said handle.

7. The apparatus of claim 1, further comprising a lid for said receptacle.

8. The apparatus of claim 1, wherein said receptacle has at least one receiving slot.

9. The apparatus of claim 1, further comprising:
an auxiliary storage area attached to said receptacle.

10. The apparatus of claim 1, wherein said handle is equipped with a plurality of light sources.

11. The apparatus of claim 1, further comprising a rubber grip.

12. The apparatus of claim 10, wherein said auxiliary storage area is comprised of mesh.

13. The apparatus of claim 1, further comprising a storage hook.

14. The apparatus of claim 1, wherein said receptacle further comprises an ash well.

15. The apparatus of claim 3, wherein said extension assistance mechanism is a linear actuator.

16. The apparatus of claim 3, wherein said extension assistance mechanism is a hydraulic piston.

17. An ashtray comprising:
a container;
a collapsible handle, removably attached to said container.

18. The ashtray of claim 17, wherein the collapsible handle is comprised of a plurality of concentric shapes that are capable of engaging with each other via a limited friction fit.

19. A handle, comprising:
a front end;
a middle section;
a back end;
at least one container removably attached to said handle.

20. The handle of claim 19, wherein said middle section is a telescoping tube.
